(19) United States
(12) Patent Application Publication
(10) Pub. No.: US 2020/0068205 A1
(43) Pub. Date: Feb. 27, 2020

(54) GEODESIC INTRA-PREDICTION FOR PANORAMIC VIDEO CODING

(71) Applicant: Huawei Technologies Co., Ltd., Shenzhen (CN)

(72) Inventor: Sergey Yurievich IKONIN, Moscow (RU)

(21) Appl. No.: 16/666,002

(22) Filed: Oct. 28, 2019

Related U.S. Application Data
(63) Continuation of application No. PCT/RU2017/000271, filed on Apr. 27, 2017.

(51) Int. Cl. H04N 19/159; H04N 19/136; H04N 19/46; H04N 19/176

(52) U.S. Cl. CPC H04N 19/159; H04N 19/176; H04N 19/46; H04N 19/136

(57) ABSTRACT

A video encoder receives frames of spherical video, each of the frames comprising blocks of pixels. The video encoder generates a set of residuals for a current block to be encoded, by performing intra-prediction along a geodesic curve for the current block to be encoded. The video encoder provides an encoded bitstream based on sets of residuals generated by the intra-prediction performed on the blocks to be encoded. A video decoder is also described.

### CROSS-REFERENCE TO RELATED APPLICATIONS

This application is a continuation of International Application No. PCT/RU2017/000271, filed on Apr. 27, 2017, the disclosure of which is hereby incorporated by reference in its entirety.

### TECHNICAL FIELD

The present application relates to the field of video coding, and more particularly to a video encoder, video decoder, and related methods and computer programs.

### BACKGROUND

360-degree video or spherical video is a new way of experiencing immersive video using devices such as head-mounted displays (HMD). This technique can provide an immersive “being there” experience for consumers by capturing a full panoramic view of the world. 360-degree video is typically recorded using a special rig of multiple cameras, or using a dedicated virtual reality (VR) camera that contains multiple embedded camera lenses. The resulting footage is then stitched to form a single video. This process may be done by the camera itself, or by using video editing software that can analyze common visuals to synchronize and link the different camera feeds together to represent the full viewing sphere surrounding the camera rig. Essentially, the camera or the camera system maps a 360° scene onto a sphere.

The stitched image (i.e. the image on the surface of the sphere) is then mapped (or unfolded) from spherical into a two-dimensional (2D) rectangular representation based on projection (such as equirectangular projection), and then encoded using e.g., standard video codecs such as H.264/AVC (Advanced Video Coding) and HEVC/H.265 (High Efficiency Video Coding).

At the viewing end, after decoding the video is mapped onto a virtual sphere with the viewer located at the center of the virtual sphere. The viewer can navigate inside the virtual sphere to see a view of the 360-degree world as desired and thereby have an immersive experience.

To reduce the bit-rate of video signals, the International Organization for Standardization (ISO) and International Telecommunication Union (ITU) coding standards apply hybrid video coding with inter-frame prediction and intra-frame prediction combined with transform coding of a prediction error. For example, intra-block prediction based on the intensity values of reference pixels from already encoded surrounding blocks may be used. Then, the intensity difference between the original block and a predicted block (called residual) may be transformed to the frequency domain using, e.g., discrete cosine transform (DCT) or discrete sine transform (DST), quantized, and coded with entropy coding.

Currently, the intra-frame prediction mechanism in video coding uses reference pixels located next to or near a block that needs to be encoded and generates a prediction signal for that block based on the intensity values of the reference pixels. The prediction signal is generated using a prediction mode which is signaled in the bitstream. The current video coding standards may use several (e.g., 33) directional modes (used to represent blocks containing edges and lines) as well as a DC mode and a planar mode. Accordingly, directional intra-frame prediction may be performed along a straight line of one of the possible (e.g., 33) directions.

In other words, the directional intra-prediction is currently performed along straight lines. During capturing of a 2D video, lines remain straight and having a prediction mechanism that takes advantage of this fact is reasonable. But during capturing of a 360-degree video and by unfolding to projection, straight lines may become distorted. E.g., for equirectangular projection straight lines become curved. Accordingly, conventional intra-frame prediction mechanisms may be inefficient for 360-degree or spherical video.

Effectiveness of the prediction influences the amount of residuals that need to be coded and transmitted. Accordingly, improving quality of prediction can reduce the amount of residual information and reduce the overall bit rate of a coded video sequence.

The expression “pixel value” means an intensity value of a pixel, i.e. an indication of an intensity of the pixel.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the invention to provide improved video coding. The foregoing and other objects are achieved by the features of the independent claims. Further implementation forms are apparent from the dependent claims, the description and the figures.

According to a first aspect a video encoder is provided, the video encoder comprising: an input unit configured to receive frames of spherical video, each of the frames comprising blocks of pixels; an intra-prediction unit configured to generate a set of residuals for a current block to be encoded, by performing intra-prediction along a geodesic curve for the current block to be encoded; and an output unit configured to provide an encoded bitstream based on sets of residuals generated by the intra-prediction performed on the blocks to be encoded. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

In a first possible implementation of the video encoder according to the first aspect, the geodesic curve with its curvature corresponds to a straight line in a three-dimensional scene represented by the spherical video. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream. Furthermore, there is no need to represent a curved line as a set of small straight lines, thus allowing savings in signaling overhead due to larger prediction blocks.

In a second possible implementation of the video encoder according to the first implementation of the first aspect, geodesic curves of different defined curvatures are used in the intra-prediction for different pixels of the current block to be encoded. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

In a third possible implementation of the video encoder according to the first implementation of the first aspect, geodesic curves of identical defined curvatures are used in the intra-prediction for different pixels of the current block to be encoded. Using similar intra-prediction curves (with identical curvatures but just shifted) for intra-prediction of all pixels or a group of pixels in a prediction block allows simplified computations.

In a fourth possible implementation of the video encoder according to the first aspect as such or according to any of the preceding implementations of the first aspect, the intra-prediction unit is configured to perform the intra-prediction for a planar projection of the spherical video. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

In a fifth possible implementation of the video encoder according to the first aspect as such or according to any of the preceding implementations of the first aspect, the intra-prediction unit is further configured to use a directional intra-prediction mode for choosing one or more parameters of the geodesic curve. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream. Furthermore, curved intra prediction can be achieved without explicit signaling of curvature parameters, thus further reducing the overall bit rate of the associated bit stream.

In a sixth possible implementation of the video encoder according to the first aspect as such or according to any of the preceding implementations of the first aspect, the intra-prediction unit is further configured to use a flag to indicate whether to perform the intra-prediction along the geodesic curve. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

According to a second aspect a video decoder is provided, the video decoder comprising: an input unit configured to receive an encoded bitstream representing frames of spherical video, each of the frames comprising blocks of pixels; an intra-prediction unit configured to determine a set of pixel values for a current block to be decoded, by performing intra-prediction along an geodesic curve for the current block to be decoded; and an output unit configured to provide decoded video based on the sets of pixel values determined by the intra-prediction performed on the blocks to be decoded. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

In a first possible implementation of the video decoder according to the second aspect, the geodesic curve with its curvature corresponds to a straight line in a three-dimensional scene represented by the spherical video. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream. Furthermore, there is no need to represent a curved line as a set of small straight lines, thus allowing savings in signaling overhead due to larger prediction blocks.

In a second possible implementation of the video decoder according to the first implementation of the second aspect, geodesic curves of different defined curvatures are used in the intra-prediction for different pixels of the current block to be decoded. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

In a third possible implementation of the video decoder according to the first implementation of the second aspect, geodesic curves of identical defined curvatures are used in the intra-prediction for different pixels of the current block to be decoded. Using similar intra-prediction curves (with identical curvatures but just shifted) for intra-prediction of all pixels or a group of pixels in a prediction block allows simplified computations.

In a fourth possible implementation of the video decoder according to the second aspect as such or according to any of the preceding implementations of the second aspect, the intra-prediction unit is configured to perform the intra-prediction for a planar projection of the spherical video. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

In a fifth possible implementation of the video decoder according to the second aspect as such or according to any of the preceding implementations of the second aspect, the intra-prediction unit is further configured to use a directional intra-prediction mode for choosing one or more parameters of the geodesic curve. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream. Furthermore, curved intra prediction can be achieved without explicit signaling of curvature parameters, thus further reducing the overall bit rate of the associated bit stream.

In a sixth possible implementation of the video decoder according to the second aspect as such or according to any of the preceding implementations of the second aspect, the intra-prediction unit is further configured to use a flag to indicate whether to perform the intra-prediction along the geodesic curve. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

According to a third aspect a method of encoding video is provided, the method comprising: receiving, by an input unit of a video encoder, frames of spherical video, each of the frames comprising blocks of pixels; generating, by an intra-prediction unit of the video encoder, a set of residuals for a current block to be encoded, by performing intra-prediction along an geodesic curve for the current block to be encoded; and providing, by an output unit of the video encoder, an encoded bitstream based on sets of residuals generated by the intra-prediction performed on the blocks to be encoded. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

In a first possible implementation of the method according to the third aspect, the geodesic curve with its curvature corresponds to a straight line in a three-dimensional scene represented by the spherical video. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream. Furthermore, there is no need to represent a curved line as a set of small straight lines, thus allowing savings in signaling overhead due to larger prediction blocks.

In a second possible implementation of the method according to the first implementation of the third aspect, geodesic curves of different defined curvatures are used in the intra-prediction for different pixels of the current block to be encoded. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

In a third possible implementation of the method according to the first implementation of the third aspect, geodesic curves of identical defined curvatures are used in the intra-prediction for different pixels of the current block to be encoded. Using similar intra-prediction curves (with identical curvatures but just shifted) for intra-prediction of all pixels or a group of pixels in a prediction block allows simplified computations.

In a fourth possible implementation of the method according to the third aspect as such or according to any of the preceding implementations of the third aspect, the method further comprises performing, by the intra-prediction unit of the video encoder, the intra-prediction for a planar projection of the spherical video. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

In a fifth possible implementation of the method according to the third aspect as such or according to any of the preceding implementations of the third aspect, the method further comprises using, by the intra-prediction unit of the video encoder, a directional intra-prediction mode for choosing one or more parameters of the geodesic curve. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream. Furthermore, curved intra prediction can be achieved without explicit signaling of curvature parameters, thus further reducing the overall bit rate of the associated bit stream.

In a sixth possible implementation of the method according to the third aspect as such or according to any of the preceding implementations of the third aspect, the method further comprises using, by the intra-prediction unit of the video encoder, a flag to indicate whether to perform the intra-prediction along the geodesic curve. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

In an seventh possible implementation of the method according to the third aspect as such or according to any of the preceding implementations of the third aspect, a computer program comprising program code is configured to perform the method, when the computer program is executed on a computer. The intra-prediction is adjusted to the geometry of spherical video, thereby allowing more efficient intra-prediction for spherical video. More efficient intra-prediction allows reducing the amount of residual information that needs to be encoded and transmitted, thus reducing the overall bit rate of an associated bit stream.

According to a fourth aspect a method of decoding video is provided, the method comprising: receiving, by an input unit of a video decoder, an encoded bitstream representing frames of spherical video, each of the frames comprising blocks of pixels; determining, by an intra-prediction unit of the video decoder, a set of pixel values for a current block to be decoded, by performing intra-prediction along an geodesic curve for the current block to be decoded; and providing, by an output unit of the video decoder, decoded video based on the sets of pixel values determined by the intra-prediction performed on the blocks to be decoded. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

In a first possible implementation of the method according to the fourth aspect, the geodesic curve with its curvature corresponds to a straight line in a three-dimensional scene represented by the spherical video. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream. Furthermore, there is no need to represent a curved line as a set of small straight lines, thus allowing savings in signaling overhead due to larger prediction blocks.

In a second possible implementation of the method according to the first implementation of the fourth aspect, geodesic curves of different defined curvatures are used in the intra-prediction for different pixels of the current block to be decoded. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

In a third possible implementation of the method according to the first implementation of the fourth aspect, geodesic curves of identical defined curvatures are used in the intra-prediction for different pixels of the current block to be decoded. Using similar intra-prediction curves (with identical curvatures but just shifted) for intra-prediction of all pixels or a group of pixels in a prediction block allows simplified computations.

In a fourth possible implementation of the method according to the fourth aspect as such or according to any of the preceding implementations of the fourth aspect, the method further comprises performing, by the intra-prediction unit of the video decoder, the intra-prediction for a planar projection of the spherical video. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

In a fifth possible implementation of the method according to the fourth aspect as such or according to any of the preceding implementations of the fourth aspect, the intra-prediction unit is further configured to use a directional intra-prediction mode for choosing one or more parameters of the geodesic curve. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream. Furthermore, curved intra prediction can be achieved without explicit signaling of curvature parameters, thus further reducing the overall bit rate of the associated bit stream.

In a sixth possible implementation of the method according to the fourth aspect as such or according to any of the preceding implementations of the fourth aspect, the intra-prediction unit is further configured to use a flag to indicate whether to perform the intra-prediction along the geodesic curve. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

In a seventh possible implementation of the method according to the fourth aspect as such or according to any of the preceding implementations of the fourth aspect, a computer program comprising program code is configured to perform the method, when the computer program is executed on a computer. The intra-prediction is adjusted to the geometry of spherical video, thereby allowing more efficient intra-prediction for spherical video. More efficient intra-prediction allows reducing the amount of residual information that needs to be received and decoded, thus reducing the overall bit rate of an associated bit stream.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1A is a block diagram illustrating a video encoder according to an example;

FIG. 1B is a block diagram illustrating a video decoder according to an example;

FIG. 2A is a flow chart illustrating a method according to an example;

FIG. 2B is a flow chart illustrating a method according to an example;

FIG. 2C is a flow chart illustrating a method according to an example;

FIG. 2D is a flow chart illustrating a method according to an example;

FIG. 2E is a flow chart illustrating a method according to an example;

FIG. 3A is a flow chart illustrating a method according to an example;

FIG. 3B is a flow chart illustrating a method according to an example;

FIG. 3C is a flow chart illustrating a method according to an example;

FIG. 3D is a flow chart illustrating a method according to an example;

FIG. 3E is a flow chart illustrating a method according to an example;

FIG. 4 illustrates an example of a straight line to sphere projection;

FIG. 5 illustrates an example of great circles in equirectangular projection;

FIG. 6 illustrates an example of parallel lines to sphere projection;

FIG. 7 illustrates an example of intra-prediction along geodesic curves; and

FIG. 8 illustrates an example of using directional intra-prediction modes together with intra-prediction along geodesic curves.

Like references are used to designate like parts in the accompanying drawings.

### DETAILED DESCRIPTION

The detailed description provided below in connection with the appended drawings is intended as a description of the embodiments and is not intended to represent the only forms in which the embodiment may be constructed or utilized. However, the same or equivalent functions and structures may be accomplished by different embodiments.

In the following description, video coding arrangements and schemes are discussed in which at least a portion of intra-prediction operations are performed along a geodesic curve.

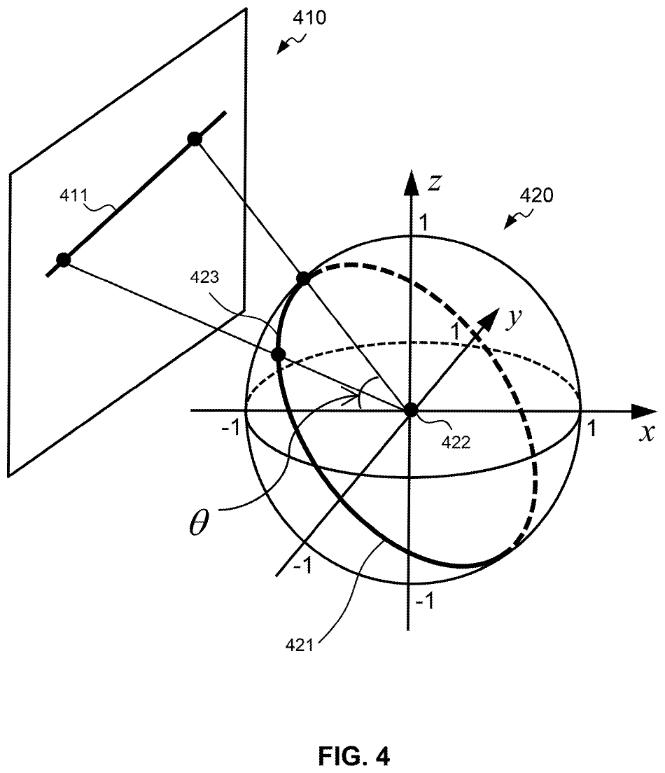

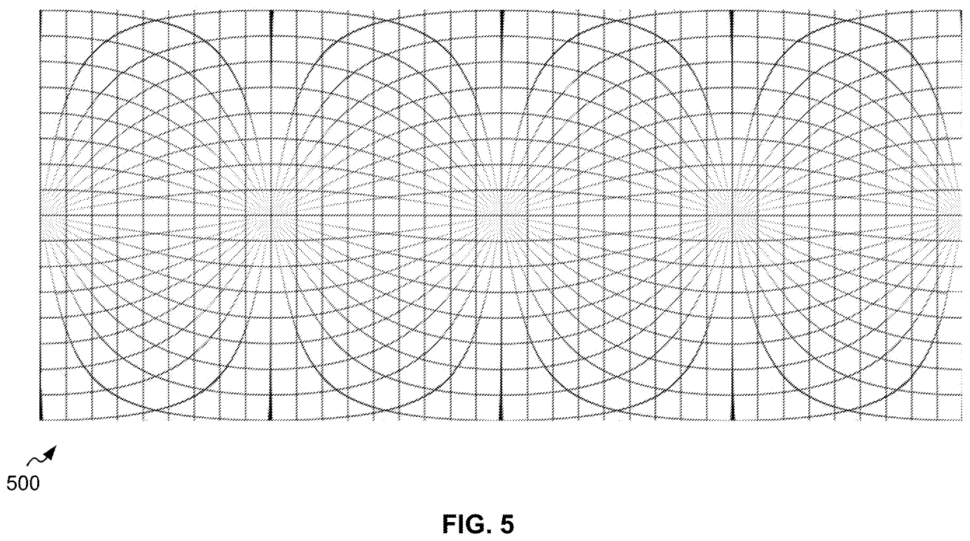

As illustrated in FIG. 4, a geodesic curve 421A is a projection of a straight line 411 of a scene 410 on a viewing sphere 420. More specifically, a geodesic curve is a part (i.e. arc 423) of a great circle 421. Great circle 421 is the intersection of the sphere and the plane defined by the straight line 411 and the sphere's center 422. FIG. 5 shows an example of great circles 500 with a spacing of 10 degrees, after unfolding from sphere to equirectangular projection. As shown in FIG. 5, straight lines become distorted in the equirectangular projected image.

From mathematics it is known that an infinite number of lines (or parts of circles or arcs) may pass through two points on a sphere. Only one of them is lying on a great circle. That means that once the position of two points of a line on a viewing sphere is known, one and only one geodesic curve can be determined coming through these two points. Parameters of curvature of this geodesic curve in the equirectangular projection (or any other type of sphere-to-2D projection) are completely defined by these two points and can be derived without explicit signaling.

In the following descriptions, a straight line is defined in a three-dimensional (3D) scene and projected onto a viewing sphere, thereby transforming the straight line into a curved intra-prediction line, i.e. a geodesic curve. Intra-prediction is performed along the intra-prediction line. More specifically, for each pixel to be predicted, a corresponding position in a reference area is obtained. This is done by passing the intra-prediction line over a current pixel to the reference area. Once the position of the current pixel is known and intra-prediction line is defined, the position in the reference area and a corresponding reference pixel value can be obtained. The reference pixel value can be taken as a predicted value (also referred to as the prediction value). Predicted values are used for subtracting from source values to obtain residuals that are then transformed and coded. It is to be noted that a reference position may be fractional in which case the prediction value may be interpolated from surrounding reference pixels on integer positions using a suitable interpolation method.

More generally, a straight line in the 3D scene may be projected onto any desired 2D projection of the 3D scene, e.g., onto a flat 2D map of the surface of the viewing sphere. Intra-prediction can thus be performed in any 2D representation of the surface of the viewing sphere.

Neighboring reference pixels, e.g., on the edge of a prediction block may be handled such that the same intra-prediction line (with the same curvature but just shifted) is also used for intra-prediction for all pixels (or for a group of pixels) in the prediction block. Alternatively, intra-prediction from a neighboring reference pixel may be done using an intra-prediction line derived from another straight line in the 3D scene.

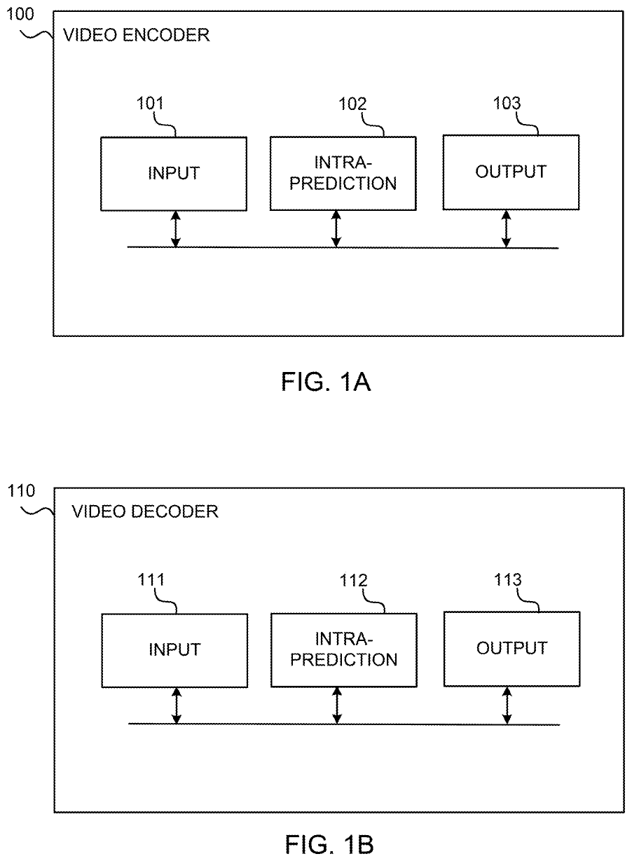

FIG. 1A is a block diagram that illustrates a video encoder 100 according to an example. The video encoder 100 may be implemented as a standalone device or it may be implemented as a part of another device, such as a digital video camera (including, e.g., 360-degree cameras and camera rigs) or the like. Furthermore, the video encoder 100 may be implemented as hardware (including but not limited to: a processor and/or a memory, and the like), software, or any combination of hardware and software.

The video encoder 100 comprises an input unit 101 that is configured to receive frames of spherical video. Each of the frames comprises blocks of pixels.

The video encoder 100 further comprises an intra-prediction unit 102 that is configured to generate a set of residuals for a current block to be encoded, by performing intra-prediction along a geodesic curve for the current block to be encoded.

The geodesic curve with its curvature may correspond to a straight line in a three-dimensional scene represented by the spherical video. Furthermore, the intra-prediction unit 102 may be configured to perform the intra-prediction for a planar projection of the spherical video. Herein, a planar projection refers to a projection onto a plane, i.e. a projection onto a flat, non-curved surface.

The video encoder 100 further comprises an output unit 103 that is configured to provide an encoded bitstream based on sets of residuals generated by the intra-prediction performed on the blocks to be encoded. In addition to residuals related data, the bitstream may comprise, e.g., partitioning flags, prediction parameters, and the like.

Geodesic curves of different defined curvatures may be used in the intra-prediction for different pixels of the current block to be encoded. Additionally or alternatively, geodesic curves of identical defined curvatures may be used in the intra-prediction for different pixels of the current block to be encoded.

The intra-prediction unit 102 may be further configured to use a directional intra-prediction mode for choosing one or more parameters of the geodesic curve.

The intra-prediction unit 102 may be further configured to use a flag to indicate whether to perform the intra-prediction along the geodesic curve.

For example, a one-bit flag may be used to signal whether straight or geodesic prediction is used for a given directional mode. Such a scheme may be applied for all directional modes or for a restricted sub-set (e.g., by excluding vertical and horizontal directions).

In another example, for some modes from a predefined set (e.g., all modes except DC, planar, vertical and horizontal) intra-prediction is switched from straight lines to the geodesic prediction. Accordingly, no additional modifications in signaling mechanism are needed. Instead, interpretation of the existing signaling may be changed. For example, all angular modes (except DC and planar) may be replaced by the geodesic prediction.

FIG. 1B is a block diagram that illustrates a video decoder 110 according to an example. The video decoder 110 may be implemented as a standalone device or it may be implemented as a part of another device, such as a display device (including, e.g., a head-mounted display suitable for displaying virtual reality content) or the like. Furthermore, the video decoder 110 may be implemented as hardware (including but not limited to: a processor and/or a memory, and the like), software, or any combination of hardware and software.

The video decoder 110 comprises an input unit 111 that is configured to receive an encoded bitstream representing frames of spherical video. Each of the frames comprises blocks of pixels.

The video decoder 110 further comprises an intra-prediction unit 112 that is configured to determine a set of pixel values for a current block to be decoded, by performing intra-prediction along a geodesic curve for the current block to be decoded.

The geodesic curve with its curvature may correspond to a straight line in a three-dimensional scene represented by the spherical video. Furthermore, the intra-prediction unit 112 may be configured to perform the intra-prediction for a planar projection of the spherical video.

The video decoder 110 further comprises an output unit 113 that is configured to provide decoded video based on the sets of pixel values determined by the intra-prediction performed on the blocks to be decoded.

Geodesic curves of different defined curvatures may be used in the intra-prediction for different pixels of the current block to be decoded. Additionally or alternatively, geodesic curves of identical defined curvatures may be used in the intra-prediction for different pixels of the current block to be decoded.

The intra-prediction unit 112 may be further configured to use a directional intra-prediction mode for choosing one or more parameters of the geodesic curve.

The intra-prediction unit 112 may be further configured to use a flag to indicate whether to perform the intra-prediction along the geodesic curve.

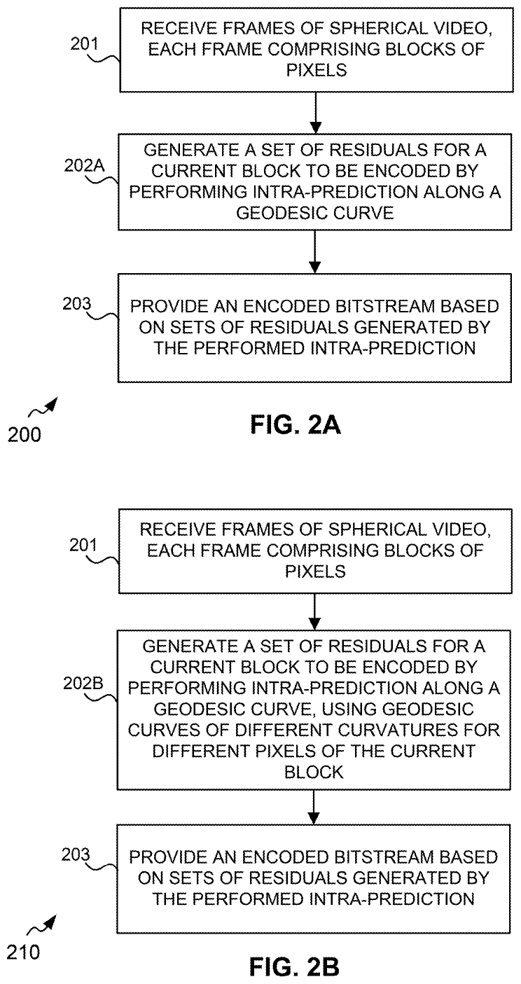

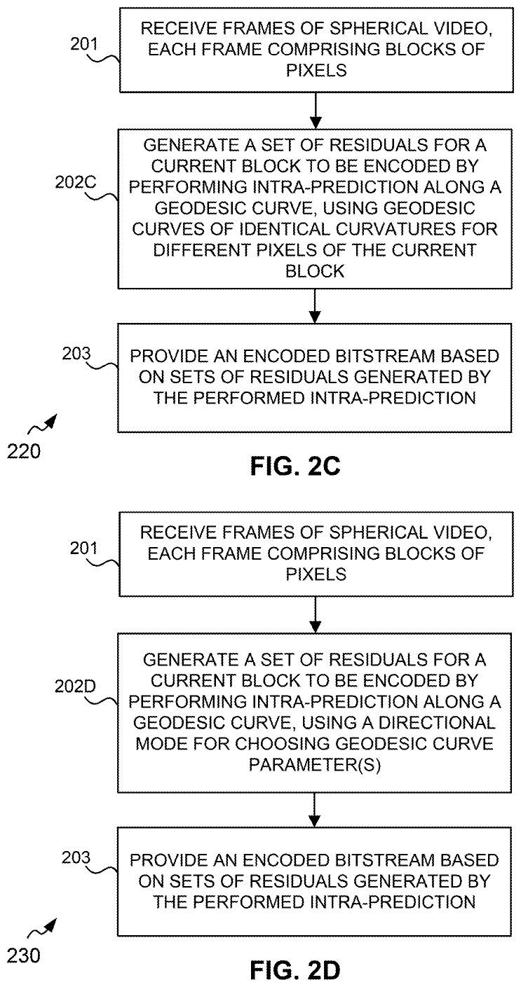

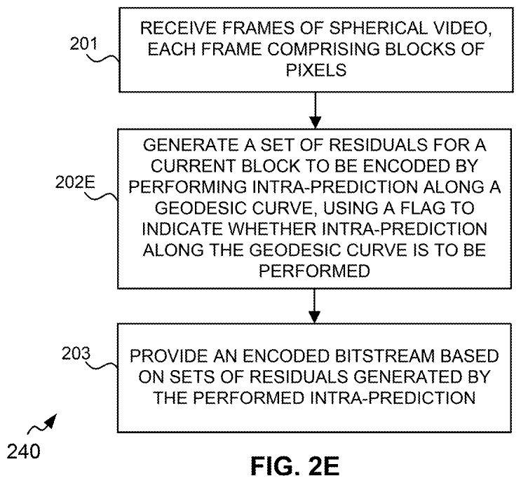

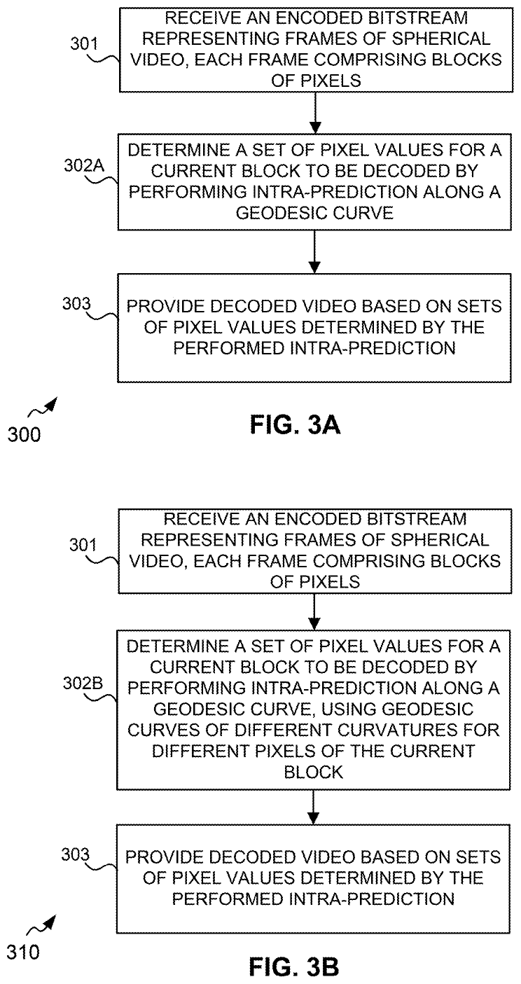

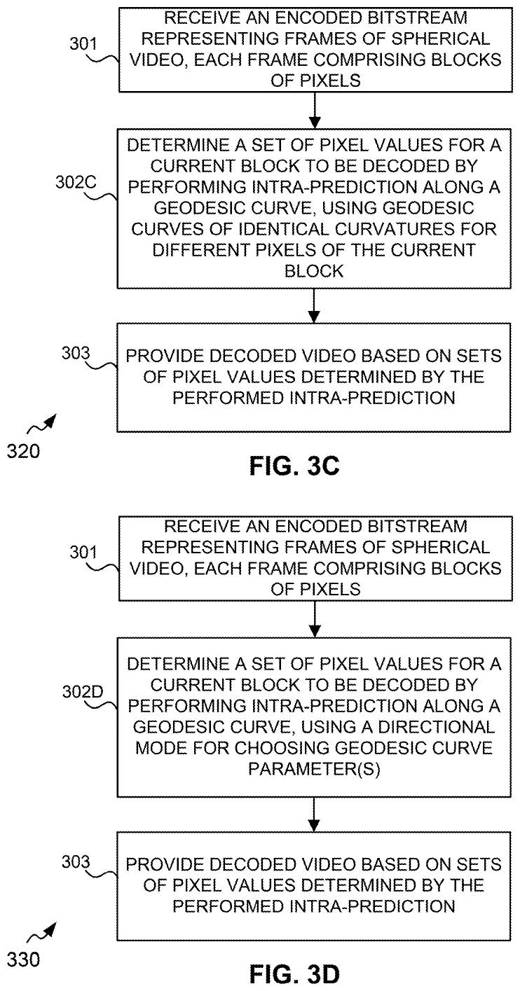

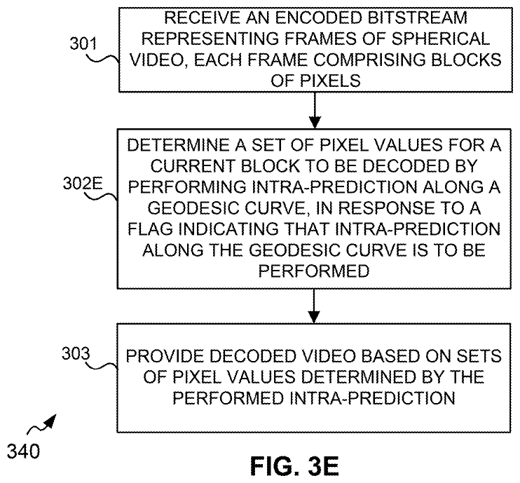

In the following examples of FIGS. 2A to 2E, the video encoder may comprise the video encoder 100 of FIG. 1A. Furthermore, in the examples of FIGS. 3A to 3E, the video decoder may comprise the video decoder 110 of FIG. 1B. Some of the features of the described devices are optional features which provide further advantages.

FIG. 2A is a flow chart illustrating a method of encoding video according to an example. At operation 201, an input unit of a video encoder receives frames of spherical video. Each of the frames comprises blocks of pixels.

At operation 202A, an intra-prediction unit of the video encoder generates a set of residuals for a current block to be encoded, by performing intra-prediction along a geodesic curve for the current block to be encoded. The geodesic curve with its curvature may correspond to a straight line in a three-dimensional scene represented by the spherical video. Furthermore, the intra-prediction may be performed for a planar projection of the spherical video.

At operation 203, an output unit of the video encoder provides an encoded bitstream based on sets of residuals generated by the intra-prediction performed on the blocks to be encoded.

FIG. 2B is a flow chart illustrating a method of encoding video according to an example. At operation 201, an input unit of a video encoder receives frames of spherical video. Each of the frames comprises blocks of pixels.

At operation 202B, an intra-prediction unit of the video encoder generates a set of residuals for a current block to be encoded, by performing intra-prediction along a geodesic curve for the current block to be encoded, and by using geodesic curves of different defined curvatures in the intra-prediction for different pixels of the current block to be encoded. The geodesic curve with its curvature may correspond to a straight line in a three-dimensional scene represented by the spherical video. Furthermore, the intra-prediction may be performed for a planar projection of the spherical video.

At operation 203, an output unit of the video encoder provides an encoded bitstream based on sets of residuals generated by the intra-prediction performed on the blocks to be encoded.

FIG. 2C is a flow chart illustrating a method of encoding video according to an example. At operation 201, an input unit of a video encoder receives frames of spherical video. Each of the frames comprises blocks of pixels.

At operation 202C, an intra-prediction unit of the video encoder generates a set of residuals for a current block to be encoded, by performing intra-prediction along a geodesic curve for the current block to be encoded, and by using geodesic curves of identical defined curvatures in the intra-prediction for different pixels of the current block to be encoded. The geodesic curve with its curvature may correspond to a straight line in a three-dimensional scene represented by the spherical video. Furthermore, the intra-prediction may be performed for a planar projection of the spherical video.

At operation 203, an output unit of the video encoder provides an encoded bitstream based on sets of residuals generated by the intra-prediction performed on the blocks to be encoded.

FIG. 2D is a flow chart illustrating a method of encoding video according to an example. At operation 201, an input unit of a video encoder receives frames of spherical video. Each of the frames comprises blocks of pixels.

At operation 202D, an intra-prediction unit of the video encoder generates a set of residuals for a current block to be encoded, by performing intra-prediction along a geodesic curve for the current block to be encoded, and by using a directional intra-prediction mode for choosing one or more parameters of the geodesic curve. The geodesic curve with its curvature may correspond to a straight line in a three-dimensional scene represented by the spherical video. Furthermore, the intra-prediction may be performed for a planar projection of the spherical video.

At operation 203, an output unit of the video encoder provides an encoded bitstream based on sets of residuals generated by the intra-prediction performed on the blocks to be encoded.

FIG. 2E is a flow chart illustrating a method of encoding video according to an example. At operation 201, an input unit of a video encoder receives frames of spherical video. Each of the frames comprises blocks of pixels.

At operation 202E, an intra-prediction unit of the video encoder generates a set of residuals for a current block to be encoded, by performing intra-prediction along a geodesic curve for the current block to be encoded, and using a flag to indicate whether to perform the intra-prediction along the geodesic curve. The geodesic curve with its curvature may correspond to a straight line in a three-dimensional scene represented by the spherical video. Furthermore, the intra-prediction may be performed for a planar projection of the spherical video.

At operation 203, an output unit of the video encoder provides an encoded bitstream based on sets of residuals generated by the intra-prediction performed on the blocks to be encoded.

FIG. 3A is a flow chart illustrating a method of decoding video according to an example. At operation 301, an input unit of a video decoder receives an encoded bitstream representing frames of spherical video. Each of the frames comprises blocks of pixels.

At operation 302A, an intra-prediction unit of the video decoder determines a set of pixel values for a current block to be decoded, by performing intra-prediction along a geodesic curve for the current block to be decoded. The geodesic curve with its curvature may correspond to a straight line in a three-dimensional scene represented by the spherical video. Furthermore, the intra-prediction may be performed for a planar projection of the spherical video.

At operation 303, an output unit of the video decoder provides decoded video based on the sets of pixel values determined by the intra-prediction performed on the blocks to be decoded.

FIG. 3B is a flow chart illustrating a method of decoding video according to an example. At operation 301, an input unit of a video decoder receives an encoded bitstream representing frames of spherical video. Each of the frames comprises blocks of pixels.

At operation 302B, an intra-prediction unit of the video decoder determines a set of pixel values for a current block to be decoded, by performing intra-prediction along a geodesic curve for the current block to be decoded, and by using geodesic curves of different defined curvatures in the intra-prediction for different pixels of the current block to be encoded. The geodesic curve with its curvature may correspond to a straight line in a three-dimensional scene represented by the spherical video. Furthermore, the intra-prediction may be performed for a planar projection of the spherical video.

At operation 303, an output unit of the video decoder provides decoded video based on the sets of pixel values determined by the intra-prediction performed on the blocks to be decoded.

FIG. 3C is a flow chart illustrating a method of decoding video according to an example. At operation 301, an input unit of a video decoder receives an encoded bitstream representing frames of spherical video. Each of the frames comprises blocks of pixels.

At operation 302C, an intra-prediction unit of the video decoder determines a set of pixel values for a current block to be decoded, by performing intra-prediction along a geodesic curve for the current block to be decoded, and by using geodesic curves of identical defined curvatures in the intra-prediction for different pixels of the current block to be encoded. The geodesic curve with its curvature may correspond to a straight line in a three-dimensional scene represented by the spherical video. Furthermore, the intra-prediction may be performed for a planar projection of the spherical video.

At operation 303, an output unit of the video decoder provides decoded video based on the sets of pixel values determined by the intra-prediction performed on the blocks to be decoded.

FIG. 3D is a flow chart illustrating a method of decoding video according to an example. At operation 301, an input unit of a video decoder receives an encoded bitstream representing frames of spherical video. Each of the frames comprises blocks of pixels.

At operation 302D, an intra-prediction unit of the video decoder determines a set of pixel values for a current block to be decoded, by performing intra-prediction along a geodesic curve for the current block to be decoded, and by using a directional intra-prediction mode for choosing one or more parameters of the geodesic curve. The geodesic curve with its curvature may correspond to a straight line in a three-dimensional scene represented by the spherical video. Furthermore, the intra-prediction may be performed for a planar projection of the spherical video.

At operation 303, an output unit of the video decoder provides decoded video based on the sets of pixel values determined by the intra-prediction performed on the blocks to be decoded.

FIG. 3E is a flow chart illustrating a method of decoding video according to an example. At operation 301, an input unit of a video decoder receives an encoded bitstream representing frames of spherical video. Each of the frames comprises blocks of pixels.

At operation 302E, an intra-prediction unit of the video decoder determines a set of pixel values for a current block to be decoded, by performing intra-prediction along a geodesic curve for the current block to be decoded in response to a flag indicating that intra-prediction along the geodesic curve is to be performed. The geodesic curve with its curvature may correspond to a straight line in a three-dimensional scene represented by the spherical video. Furthermore, the intra-prediction may be performed for a planar projection of the spherical video.

At operation 303, an output unit of the video decoder provides decoded video based on the sets of pixel values determined by the intra-prediction performed on the blocks to be decoded.

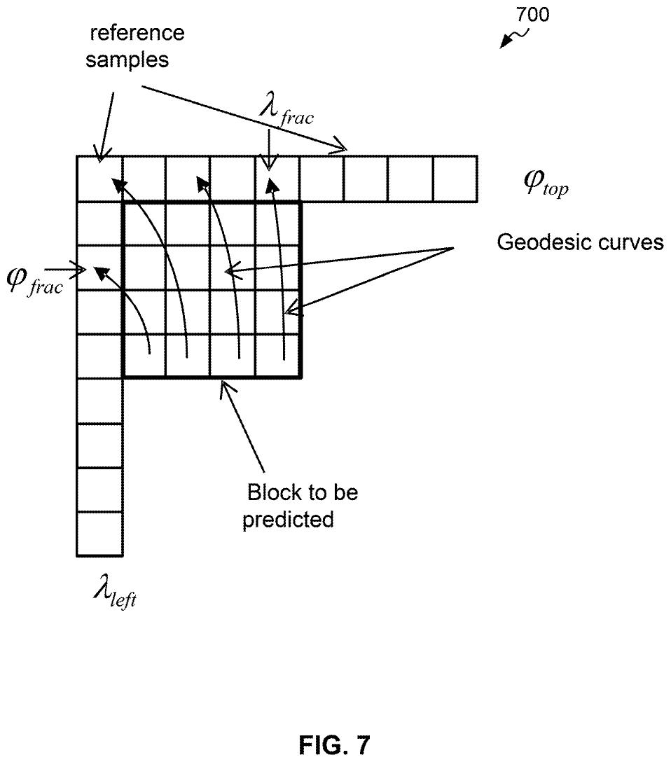

FIG. 7 further illustrates an example 700 of intra-prediction along geodesic curves in accordance with the examples of FIGS. 1A-3E.

As discussed above, a geodesic curve is a part of a great circle. The great circle is a circle on the viewing sphere inside the plane defined by the straight line and the sphere's center. When the elevation angle of an azimuth angle of 0 is θ, the great circle can be expressed as:

φ=tan⁻¹(tan θ cos λ)

Equirectangular projection has the following equations for forward projection:

x=(λ−λ₀)*cos φ₀

y=(φ−φ₀)

and for backward projection:

$$λ = \frac{x}{cos {ϕ}_{0}} + {λ}_{0}$$

$$ϕ = y + {ϕ}_{0}$$

where φ, λ are the spherical coordinates of a pixel on the viewing sphere, x, y are corresponding coordinates on the equirectangular projection, φₒ, λ₀ are spherical coordinates of a standard parallel and central meridian, e.g., the starting point of a spherical coordinate system.

When φ₀=0; λ₀=0, the conversion equations become:

x=λ

y=φ.

Unfolding from the spherical to equirectangular projection transforms the great circles (i.e. the intra-prediction lines on the viewing sphere) into curves, as shown in FIG. 5. As discussed above, prediction may be performed along these curves.

As discussed above in connection with FIG. 4, an infinite number of lines (or parts of circles or arcs) may pass through two points on a sphere. Only one of them is lying on a great circle. That means that once the position of two points of a line on a viewing sphere is known, one and only one geodesic curve can be determined coming through these two points. Here, one of the points may be a current pixel to be predicted. The other point may vary depending on the implementation. For example, the starting point of the coordinate system may be shifted to this other point. The shifting of the starting point may be applied, e.g., during the conversion from the equirectangular projection to the spherical coordinates, and vice versa. Alternatively, the starting shift may be taken directly in equations. In that case, the great circle equation will be:

φ=tan⁻¹ (tan·θ cos(λ−λ₀))+φ₀

It is to be understood that the starting point may alternatively be defined in picture projection coordinates instead of spherical coordinates.

Again referring to FIG. 7, the intra-prediction along geodesic curves may include operations in which for each pixel to be predicted with picture position x, y:
A1. the pixel position is converted to spherical coordinates, with the starting point of the coordinate system set to φ₀, λ₀:

$$λ = \frac{x}{cos {ϕ}_{0}} + {λ}_{0}$$

$$ϕ = y + {ϕ}_{0}$$

A2. the elevation angle of the geodesic line coming through this point to the starting point of the coordinate system is defined as:

$$θ = {tan}^{- 1} ( \frac{tan ϕ}{cos λ} )$$

A3. the coordinate of a pixel lying on the reference line is defined using:

$${ϕ}_{frac} = {tan}^{- 1} ( \frac{tan θ}{cos {λ}_{left}} )$$

for prediction from a horizontal reference, and

$${λ}_{frac} = {cos}^{- 1} ( \frac{tan {ϕ}_{top}}{tan θ} )$$

for prediction from a vertical reference, where φₜₒₚ, λ_{left} are the coordinates of top and left reference lines, respectively, and φ_{frac}, λ_{frac} are the defined fractional positions on the reference line
A4. the fractional position is converted back to the picture position coordinates:

x=(λ−λ₀)*cos φ₀

y=(φ−φ₀)
A5. the predicted pixel value is interpolated using fractional reference coordinates with a suitable interpolation method.

By applying different 2D-to-sphere conversion formulas on the above operations 1 and 4, this can be adopted to any type of sphere-to-2D projection rather than only to equirectangular projection.

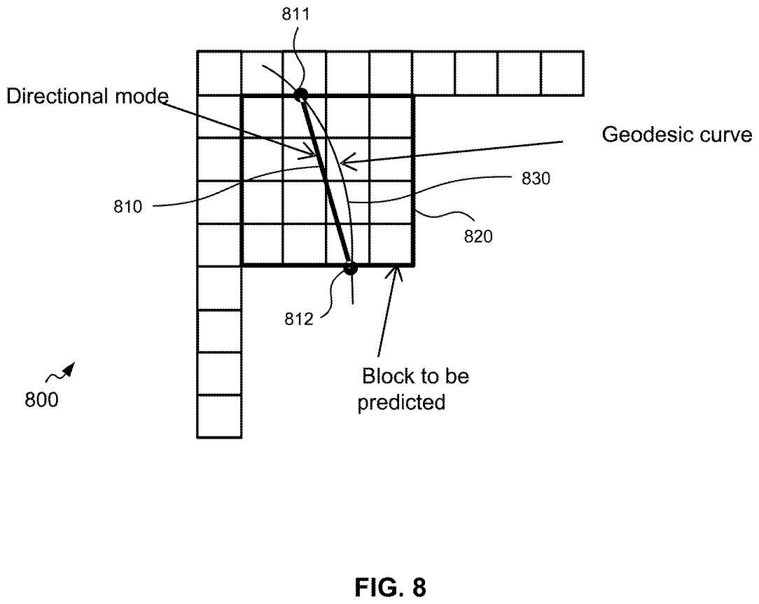

FIG. 8 further illustrates an example 800 of using directional intra-prediction modes together with intra-prediction along geodesic curves in accordance with the examples of FIGS. 1A-3E.

Here, a straight line 810 goes across the block 820 (e.g., through block center) with an angle that corresponds to a directional intra-prediction mode. Two points inside the current block and lying on this line 810 are selected, e.g., the points 811, 812 in which the line 810 crosses the border of the block 820. Alternatively, e.g., the center of the block 820 may be chosen as the first point, and another point located at a distance of, e.g., 1 pixel from the first one may be chosen as the second point. In other words, an angular or directional intra-prediction mode may be used as a tangent to a geodesic curve 830. By choosing different angular intra-prediction modes it is possible to select geodesic curves of different parameters.

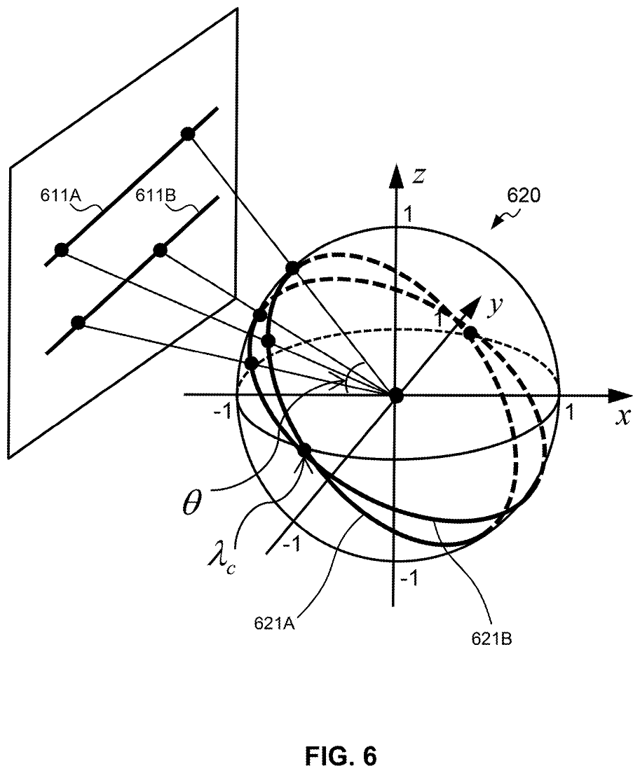

Furthermore, here parallel lines 611A, 611B are projected into two great circles 621A, 621B on a unit sphere 620 crossing in some point on the equator with coordinates φ=0, λ=λ_{c}, as shown in the example of FIG. 6. This point may be chosen by a given angular direction, and all geodesic curves for the current block may be drawn through this point. Thus, the associated intra-prediction operations may include:

For a given angular direction:

B1. two points inside the current block (or in the neighborhood of the current block) are chosen lying on a straight line with an angle according to the given angular direction. As an example, these may be the two points 811, 812 in which the straight line 810 coming through the center of the block 820 crosses the block borders (FIG. 8).

B2. they are converted to spherical coordinates with the starting point at φ₀=0; λ₀=0 using:

λ=x

φ=y

B3. the position of a point in which the great circle coming through the given two points crosses the equator is obtained by solving the equation:

$${λ}_{o} = {tan}^{- 1} ( \frac{cos {λ}_{1} - \frac{tg {ϕ}_{1}}{tg {ϕ}_{2}} cos {λ}_{2}}{sin {λ}_{1} - \frac{tg {ϕ}_{1}}{tg {ϕ}_{2}} sin {λ}_{2}} )$$

where φ₁, λ₁ and φ₂, λ₂ are the spherical coordinates of the two points 811, 812 selected above in step 1

B4. the starting point of the spherical coordinate system for next steps is chosen as:

λ=λ₀

φ=0

B5. for each point in the block to be predicted, the above described intra-prediction operations A1-A5 may then be performed.

The above operations B1-B5 allow geodesic intra-prediction in different directions using a signaling mechanism based on angular prediction intra-prediction modes.

The functionality described herein can be performed, at least in part, by one or more computer program product components such as software components. According to an embodiment, the video encoder 100 and/or video decoder 110 comprise a processor configured by program code to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

What is claimed is:

1. A video encoder comprising:
an input unit configured to receive frames of spherical video, each of the frames comprising blocks of pixels;
an intra-prediction unit configured to generate a set of residuals for a current block to be encoded, by performing intra-prediction along a geodesic curve for the current block to be encoded; and
an output unit configured to provide an encoded bitstream based on sets of residuals generated by the intra-prediction performed on the blocks to be encoded.

2. The video encoder according to claim 1, wherein the geodesic curve with its curvature corresponds to a straight line in a three-dimensional scene represented by the spherical video.

3. The video encoder according to claim 2, wherein geodesic curves of different defined curvatures are used in the intra-prediction for different pixels of the current block to be encoded.

4. The video encoder according to claim 2, wherein geodesic curves of identical defined curvatures are used in the intra-prediction for different pixels of the current block to be encoded.

5. The video encoder according to claim 1, wherein the intra-prediction unit is configured to perform the intra-prediction for a planar projection of the spherical video.

6. The video encoder according to claim 1, wherein the intra-prediction unit is further configured to use a directional intra-prediction mode for choosing one or more parameters of the geodesic curve.

7. The video encoder according to claim 1, wherein the intra-prediction unit is further configured to use a flag to indicate whether to perform the intra-prediction along the geodesic curve.

8. A video decoder comprising:
an input unit configured to receive an encoded bitstream representing frames of spherical video, each of the frames comprising blocks of pixels;
an intra-prediction unit configured to determine a set of pixel values for a current block to be decoded, by performing intra-prediction along a geodesic curve for the current block to be decoded; and
an output unit configured to provide decoded video based on the sets of pixel values determined by the intra-prediction performed on the blocks to be decoded.

9. The video decoder according to claim 8, wherein the geodesic curve with its curvature corresponds to a straight line in a three-dimensional scene represented by the spherical video.

10. The video decoder according to claim 9, wherein geodesic curves of different defined curvatures are used in the intra-prediction for different pixels of the current block to be decoded.

11. The video decoder according to claim 9, wherein geodesic curves of identical defined curvatures are used in the intra-prediction for different pixels of the current block to be decoded.

12. The video decoder according to claim 8, wherein the intra-prediction unit is configured to perform the intra-prediction for a planar projection of the spherical video.

13. A method of encoding video, the method comprising:
receiving, by an input unit of a video encoder, frames of spherical video, each of the frames comprising blocks of pixels;
generating, by an intra-prediction unit of the video encoder, a set of residuals for a current block to be encoded, by performing intra-prediction along a geodesic curve for the current block to be encoded; and
providing, by an output unit of the video encoder, an encoded bitstream based on sets of residuals generated by the intra-prediction performed on the blocks to be encoded.

14. A computer program comprising program code configured to perform a method according to claim 13, when the computer program is executed on a computer.

15. A method of decoding video comprising:
receiving, by an input unit of a video decoder, an encoded bitstream representing frames of spherical video, each of the frames comprising blocks of pixels;
determining, by an intra-prediction unit of the video decoder, a set of pixel values for a current block to be decoded, by performing intra-prediction along a geodesic curve for the current block to be decoded; and
providing, by an output unit of the video decoder, decoded video based on the sets of pixel values determined by the intra-prediction performed on the blocks to be decoded.

16. A computer program product comprising program code configured to perform a method according to claim 15 when the computer program is executed on a computer.
